(19) United States
(12) Patent Application Publication
(10) Pub. No.: US 2006/0187765 A1
(43) Pub. Date: Aug. 24, 2006

(54) Third wheel & pinion disengaging structure and timepiece possessing the same

(76) Inventor: Taichi Haga, Chiba-shi (JP)

Correspondence Address: BRUCE L. ADAMS, ESQ., SUITE 1231, 17 BATTERY PLACE, NEW YORK, NY, 10004, US

(21) Appl. No.: 11/356,667

(22) Filed: Feb. 17, 2006

(30) Foreign Application Priority Data
Feb. 22, 2005 (JP) 2005-046136

(51) Int. Cl. G04B 19/02

(52) U.S. Cl. 368/220

(57) ABSTRACT

To provide a third wheel & pinion disengaging structure which makes a hand setting complying with a pulling-out of a winding stem possible and can prevent a second hand from shaking even if undergoes an impact on the occasion of the hand setting, and a timepiece possessing the same. In a third wheel & pinion disengaging structure of a timepiece, a lever rotated in a plane with respect to a base body in compliance with a putting-in/out of a winding stem in A1, A2 directions possesses a third pinion setting part pressed to a third pinion in compliance with a pulling-out of the winding stem-and causing the third pinion to separate from a center wheel. It additionally has a third wheel & pinion biasing spring possessing a hole part to which a third spindle is fitted and causing a third wheel & pinion to elastically bias to a position meshing with a center wheel & pinion, and the third pinion setting part of the lever is pressed to the third pinion in compliance with the pulling-out of the winding stem and causes the third pinion to separate from the center wheel while resisting against an elastic biasing force of the third wheel & pinion biasing spring. The spring may be formed in the base body, or formed in the lever.

### BACKGROUND OF THE INVENTION

1. Field of the Invention

The present invention is concerned with a third wheel & pinion disengaging structure of a timepiece.

2. Description of the Prior Art

There is known a third wheel & pinion disengaging structure adapted such that a third wheel & pinion is disengaged from a center wheel & pinion by providing a tenon holding part, to which a tenon of the third wheel & pinion is fitted, in a lever rotated in a plane with respect to a main plate in compliance with a putting-in/out of a winding stem and by a movement, of the tenon holding part, complying with a rotation accompanying a pulling-out of the winding stem (JP-UM-B-63-29270 Gazette, JP-A-63-173991 Gazette).

In this third wheel & pinion disengaging structure of the JP-UM-B-63-29270 Gazette, by the fact that the third wheel & pinion is disengaged from the center wheel & pinion by the lever rotated accompanying the pulling-out of the winding stem, even if an hour hand and a minute hand are rotated on the occasion of a hand setting by rotating the winding stem, a rotation of the center wheel & pinion (minute wheel) can be avoided from being transmitted to a second hand.

However, in this third wheel & pinion disengaging structure disclosed in the JP-UM-B-63-29270 Gazette, since rotations of the third wheel & pinion and a second wheel & pinion (second wheel) meshing with the former become free, there is a fear that, if undergoes an impact on the occasion of the hand setting, the second hand shakes.

The present invention is one made in view of the point mentioned above, and its object is to provide a third wheel & pinion disengaging structure which makes the hand setting complying with the pulling-out of the winding stem possible and can prevent the second hand from shaking even if undergoes the impact on the occasion of the hand setting, and a timepiece possessing the same.

### SUMMARY OF THE INVENTION

In order to achieve the above object, in a third wheel & pinion disengaging structure of the present invention, a lever rotated in a plane with respect to a base body in compliance with a putting-in/out of a winding stem possesses a third pinion setting part pressed to a third pinion in compliance with a pulling-out of the winding stem and causing the third pinion to separate from a center wheel.

In the third wheel & pinion disengaging structure of the present invention, since “the third pinion setting part of the lever rotated in the plane with respect to the base body in compliance with the putting-in/out of the winding stem causes the third pinion to separate from a center wheel in compliance with the pulling-out of the winding stem”, a mesh between a third wheel & pinion and a center wheel & pinion is released in compliance with the pulling-out of the winding stem and, even if the hour hand and the minute hand are rotated on the occasion of the hand setting by rotating the winding stem existing in a pulled-out position, a rotation of the center wheel & pinion (minute wheel) can be avoided from being transmitted to a second wheel through the third wheel & pinion, so that the second hand can be avoided from rotating. Further, in the third wheel & pinion disengaging structure of the present invention, especially since “the third pinion setting part of the lever is pressed to the third pinion in compliance with the pulling-out of the winding stem when the third pinion is separated from the center wheel”, a rotation of the third wheel & pinion can be set (restricted) prohibited by the third pinion setting part of the lever. Accordingly, since a rotation of a second wheel & pinion (second wheel) having meshed with the third can be prohibited by the third wheel & pinion even under a state that the third wheel & pinion has been disengaged from the center wheel & pinion, there is no fear that the second hand shakes even if undergoes the impact and the like on the occasion of the hand setting.

In the third wheel & pinion disengaging structure of the present invention, although a third spindle may be supported in what manner so long as it can be displaced by the third pinion setting part of the lever, typically “it has additionally a third wheel & pinion biasing spring possessing a hole part to which the third spindle is fitted and causing the third wheel & pinion to elastically bias to a position meshing with the center wheel & pinion, and the third pinion setting part of the lever is pressed to the third pinion in compliance with the pulling-out of the winding stem and causes the third pinion to separate from the center wheel while resisting against an elastic biasing force of the third wheel & pinion biasing spring”.

In this case, if the winding stem is pushed and returned to a normal hand moving position (0th stage), the third wheel & pinion biasing spring biases the third wheel & pinion, thereby being capable of causing the third wheel & pinion to mesh again with the center wheel & pinion. Further, it becomes also possible that the elastic biasing force of the third wheel & pinion biasing spring gives a setting force of the rotation of the third pinion by the third pinion setting part.

This third wheel & pinion biasing spring is typically formed in the base body disposed stationarily with respect to a case of the timepiece. However, if desired, the third wheel & pinion biasing spring may be formed in a component movable with respect to the case and, for example, the third wheel & pinion biasing spring may be formed in the lever itself.

In a case of the former, the third wheel & pinion disengaging structure of the present invention takes a form of “a third wheel & pinion disengaging structure having a lever rotated in a plane with respect to a base body in compliance with a putting-in/out of a winding stem, and a third wheel & pinion biasing spring formed in the base body, possessing a hole part to which a third spindle is fitted, and causing a third wheel & pinion to elastically bias to a position meshing with a center wheel & pinion, wherein the lever has a third pinion setting part pressed to a third pinion in compliance with a pulling-out of the winding stem and causing the third pinion to separate from a center wheel while resisting against an elastic biasing force of the third wheel & pinion biasing spring”.

In a timepiece possessing the third wheel & pinion disengaging structure like this, it is possible to prevent a shake of the second hand on the occasion of the hand setting while suppressing a cost to a lowest limit.

### BRIEF DESCRIPTION OF THE SEVERAL VIEWS OF THE DRAWINGS

A preferred form of the present invention is illustrated in the accompanying drawings in which:

FIG. 1 is a plan explanatory view showing a state that a timepiece possessing a third wheel & pinion disengaging structure of one preferred embodiment according to the present invention exists in a winding stem 0th stage;

FIG. 2 is a sectional explanatory view of the timepiece of FIG. 1;

FIG. 3 is a perspective explanatory view showing a spring part of a main plate of the timepiece of FIG. 1;

FIG. 4 is a plan explanatory view, similar to FIG. 1, showing a state that the timepiece of FIG. 1 exists in a winding stem 1st stage;

FIG. 5 is a sectional explanatory view, similar to FIG. 2, about the timepiece of FIG. 4;

FIG. 6 is a plan explanatory view, similar to FIG. 1, about a state that the timepiece possessing the third wheel & pinion disengaging structure of a modified example according to the present invention exists in the winding stem 0th stage;

FIG. 7 is a sectional explanatory view, similar to FIG. 2, about the timepiece of FIG. 6;

FIG. 8 is a perspective explanatory view showing a spring part and the like of a lever of the timepiece of FIG. 6;

FIG. 9 is a plan explanatory view, similar to FIG. 6, showing the state that the timepiece of FIG. 6 exists in the winding stem 1st stage; and

FIG. 10 is a sectional explanatory view, similar to FIG. 7, about the timepiece of FIG. 9.

### DETAILED DESCRIPTION OF THE PREFERRED EMBODIMENTS

Next, one preferred implementation mode of the present invention is explained on the basis of a preferred embodiment shown in the appended drawings.

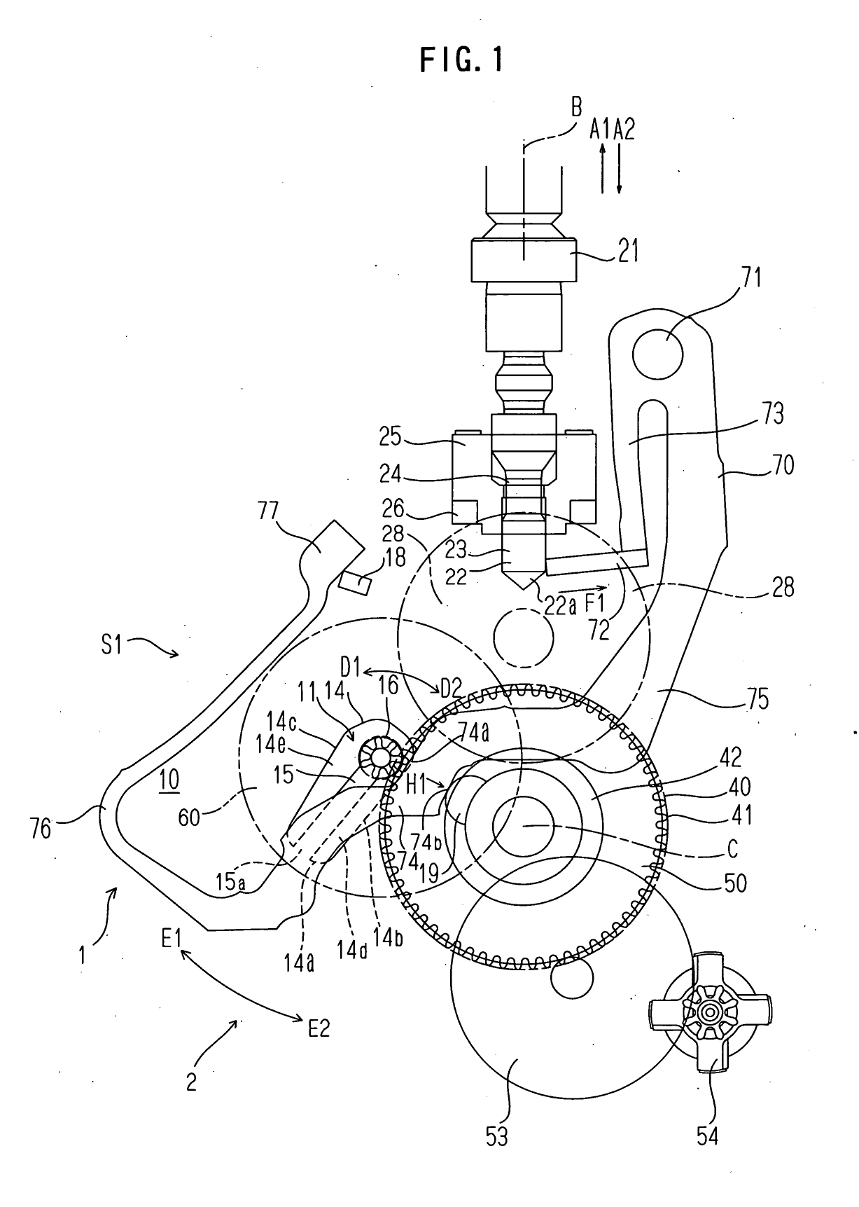

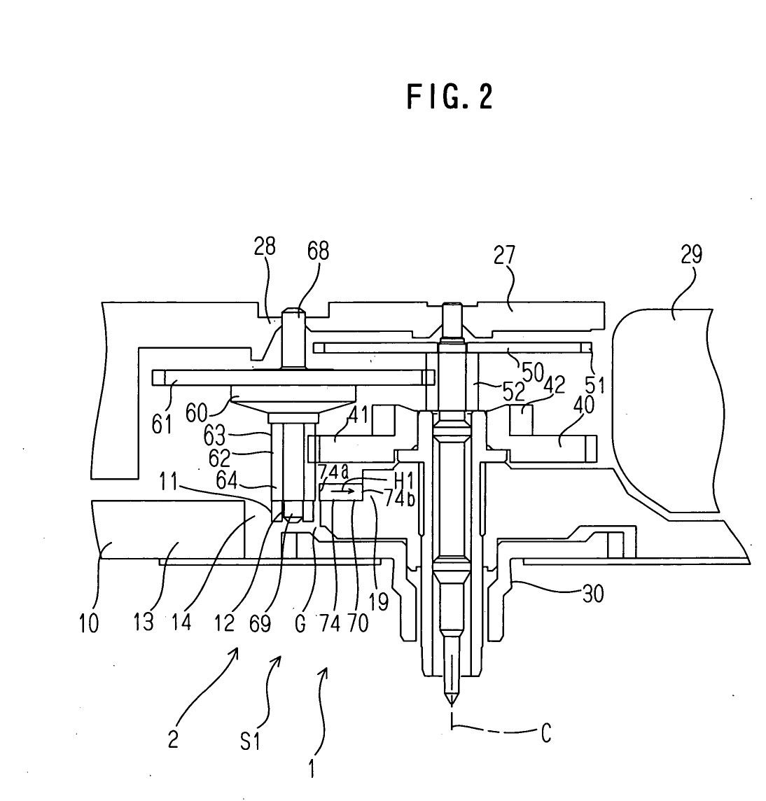

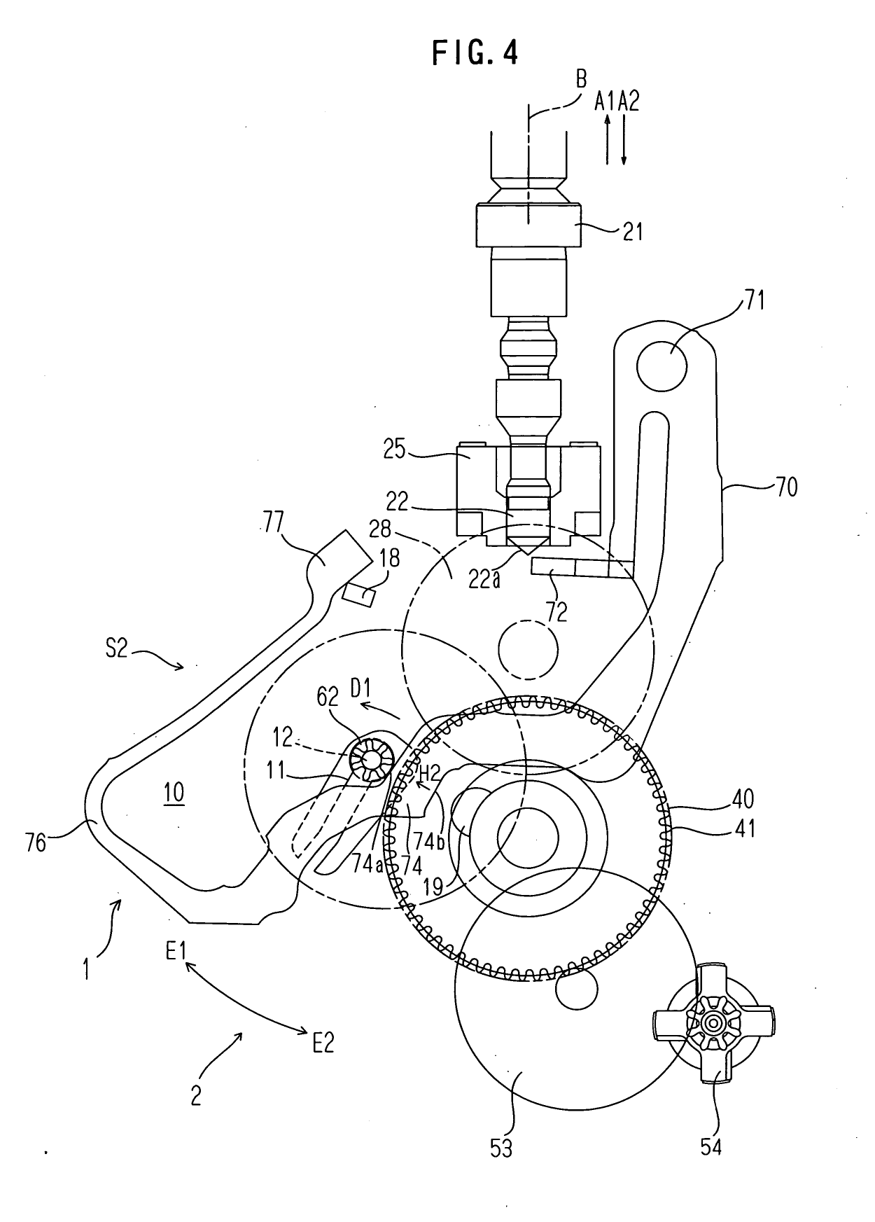

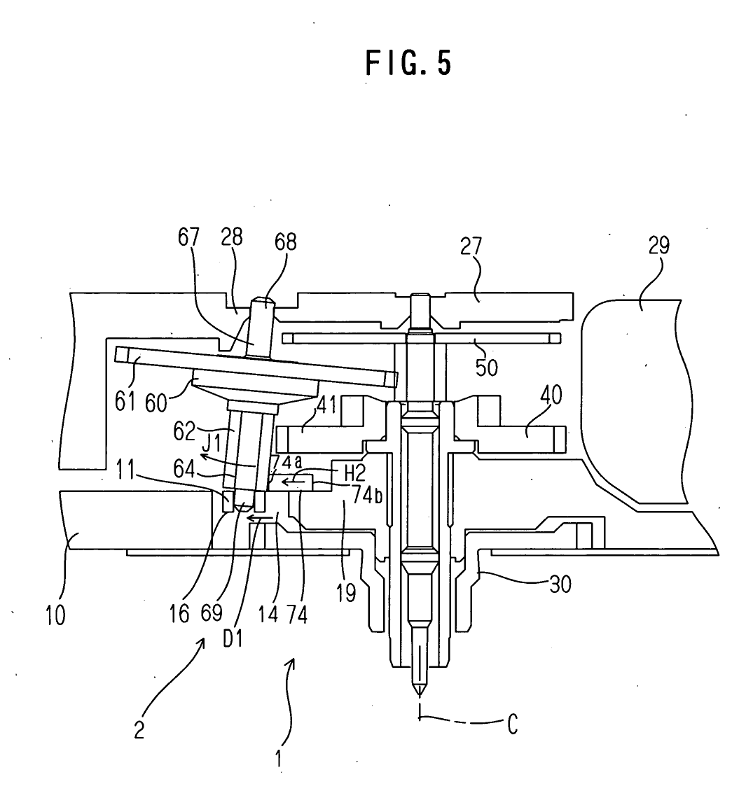

In one preferred embodiment, according to the present invention, shown in FIG. 1 to FIG. 5, a timepiece 1 possesses a winding stem 21 which is capable of being pulled out and pushed in A1, A2 directions with respect to a main plate 10, and can, rotate about a center axis B. The winding stem 21 possesses a prismatic part 23 and a small diameter part 24 in a tip part 22. A clutch wheel 25 acting as a clutch is fitted to the tip part 22 of the winding stem 21. The clutch wheel 25 possesses an angular, tubular hole part capable of engaging with the prismatic part 23 of the winding stem 21, and possesses in its end part a clutch wheel gear part 26. The clutch wheel 25 is disposed in a concave part (not shown in the drawing) of the main plate 10 under a state that displacements in the A1, A2 directions are restricted and, under a state S1 (FIG. 1 and FIG. 2) that the winding stem 21 exists in a normal hand moving position (winding stem 0th stage) where it has been pushed in the A2 direction, it is fitted to the small diameter part 24 rotatably about the center axis B and, under a state S2 (FIG. 4 and FIG. 5) that the winding stem 21 exists in a hand setting position (winding stem 1st stage) where it has been pulled out in the A1 direction, it is fitted to the prismatic part 23 and rotatable monolithically with the winding stem 21 about the center axis B.

As shown in FIG. 2, in a dial side of the main plate 10, there is disposed an hour wheel (hour wheel) 30 rotatably about a center axis C and, between the main plate 10 and a train wheel bridge 27, there are rotatably disposed a center wheel & pinion (minute wheel) 40 and a second wheel & pinion (second wheel) 50 coaxially with the hour wheel 30. In the vicinity of the center wheel & pinion 40, there is disposed a third wheel & pinion 60.

The third wheel & pinion 60 is rotatably supported in one end 68 of a third spindle 67 by a bearing part 28 of the train wheel bridge 27, and robtatably supported in the other end 69 by a bearing hole 12 of a spring part 11 of the main plate 10.

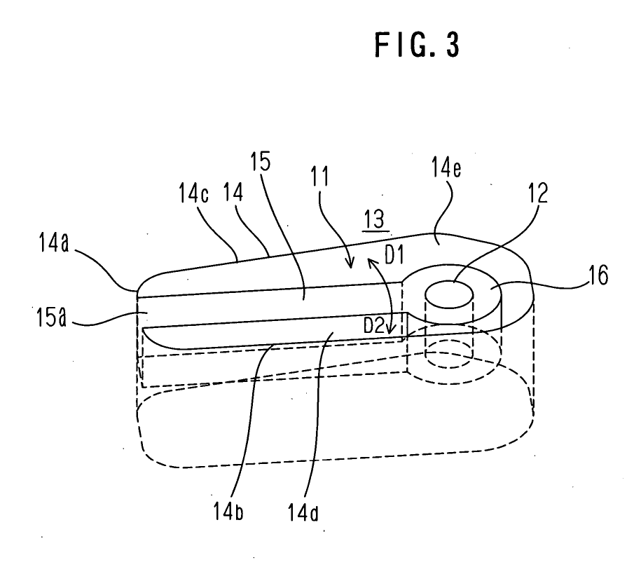

More detailedly, as shown in FIG. 3 in addition to FIG. 1, the main plate 10 possesses an elongate opening 14 formed in a main plate main body part, 13 and, in the opening 14, there is protruded the spring part 11 possessing an elongate arm part 15 and a tip bearing part 16. In the spring part 11 as a third wheel & pinion biasing spring, a base end part 15a of the arm part 15 is continuously connected to the main plate main body part 13 in one end 14a of the opening 14 in a longitudinal direction. Accordingly, the spring part 11 is rotatable or swingable in D1, D2 directions with the base end part 15a being made a basis. In the tip bearing part 16 of the spring part 11, there is formed the bearing hole 12 mentioned above. Interstices 14d, 14e between side edges 14b, 14c of the opening 14 and the spring part 11 are larger in a side (14e) separated from the center axis C than a side (14d) approaching the center axis C, so that the spring part 11 is largely swingable in the D1 direction. Incidentally, as understood from FIG. 2, a thickness of the spring part 11 is sufficiently thin in comparison that of the main body part 13 of the main plate 10, and the spring part 11 is elastically deformable so as to flex in the D1, D2 directions.

The third wheel & pinion 60 has a third wheel 61 and an elongate third pinion 62 and, under the winding stem 0th stage state (normal hand moving position) S1 shown in FIG. 1 and FIG. 2, the elongate third pinion 62 meshes in its case back side portion 63 with a center wheel 41 of the center wheel & pinion 40, and the third wheel 61 meshes with a second pinion 52 of the second wheel & pinion 50. That is, as mentioned later, under a state that a force by a lever 70 is not applied to the third pinion 62, the third pinion 62 meshes with a second wheel 51 by a D2 direction biasing force of the spring part 11 under a state pushed to the second wheel 51. Incidentally, a center pinion 42 of the center wheel & pinion 40 is connected to the hour wheel 30 through a minute wheel 28 (FIG. 1). On the other hand, the second wheel 51 of the second wheel & pinion 50 is connected to a rotor 54 of a motor through a fifth wheel & pinion 53.

On the main plate 10, the lever 70 like a sea horse is disposed so as to be rotatable in E1, E2 directions about a lever axle 71. The lever 70 has in one side of the axle 71 an arm part 73 possessing in its tip a winding stem butting part 72 butted against a tip engaging part 22a of the tip part 22 of the winding stem 21, and has in the other side an arm part 75 possessing in its intermediate part a third pinion butting/setting part 74 as a third pinion setting part capable of butting against a dial side portion 64 of the third pinion 62. In a tip part of the arm part 75, there is formed a U-shaped spring part 76, and a tip part 77 of the spring part 76 is locked to a locking protrusion part 18 formed in the main plate 10. Accordingly, an E1 direction biasing force is acting on the lever 70 by the U-shaped spring part 76.

In the above, a third wheel & pinion disengaging structure 2 of the timepiece 1 comprises the lever 70 possessing the third pinion butting/setting part 74, and the main plate 10 possessing the spring part 11.

As shown in FIG. 1 and FIG. 2, in a case where the winding stem 21 exists in the normal hand moving position (winding stem 0th stage state) S1 where it has been pushed in the A2 direction, since the tip engaging part 22a of the tip part 22 of the winding stem 21 pushes the butting part 72 of the arm part 73 of the lever 70 in an F1 direction, an E2 direction biasing force is applied to the arm part 75 through the arm part 73. Accordingly, the third pinion butting/setting part 74 is also rotation-biased in the E2 direction with the axle 71 being made a center while resisting against a spring force of the U-shaped spring part 76. As a result, as shown in FIG. 2, the third pinion butting/setting part 74 is displaced in an H1 direction, thereby butting against a locking protrusion part 19 of the main plate 10. At this time, an interstice G is formed between the third pinion butting/setting part 74 of the lever 70 and the third pinion 62. That is, the third pinion butting/setting part 74 is kept in a state separated from the third pinion 62. At this time, as shown in FIG. 1, the spring part 11 is applying in the bearing part 16 a biasing force in the D2 direction to the third pinion 62 through the tip part 69 of the third spindle 67, and the third pinion 62 is meshed with the center wheel 41 in the case back side portion 63. Accordingly, a rotation of the rotor 54 of the motor supplied with an electricity from a battery 29 is transmitted to the second wheel & pinion 50 through the fifth wheel & pinion 53, additionally transmitted to the center wheel & pinion 40 through the third wheel & pinion 60, and transmitted to the hour wheel 30 through the minute wheel 28, so that the normal hand moving of a time display hand (not shown in the drawing) is performed.

Incidentally, in the above, the D2 direction biasing force that the spring part 11 applies to the third pinion 62 suffices if it is sufficient to support a mesh/rotation between the third pinion 62 and the center wheel 41 and, so long as the mesh can be prevented from being released or becoming insufficient, under a meshing state it may be a biasing force or pushing force approximating zero in practice.

On the other hand, as shown in FIG. 4 and FIG. 5, if the winding stem 21 is set to the hand setting position (winding stem 1st stage state) S2 where it has been pulled out in the A1 direction, accompanying the pulling-out of the winding stem 21, the tip engaging part 22a of the tip part 22 of the winding stem 21 separates from the winding stem butting part 72 of the lever 70. By this, since the E2 direction biasing force to the lever 70 becomes null, the lever 70 is rotation-biased in the E₁ direction by the U-shaped spring part 76. As a result, the third pinion butting/setting part 74 of the lever 70 is displaced in an H2 direction, and a side edge part 74b separates from the locking protrusion part 19 of the main plate 10 and is pushed in the H2 direction to the dial side portion 64 of the third pinion 62 in a side edge part 74a. Accordingly, since the bearing part 16 of the spring part 11 supporting the end part 69 of the third spindle 67 is also swung in the D1-direction in the opening 14 toward the interstice 14e and the third spindle 67 is swung in a J1 direction with the end part 68 supported by the bearing part 28 of the train wheel bridge 27 being made a center, the mesh between the third pinion 62 and the center wheel 41 is released. Incidentally, since the third pinion butting/setting part 74 of the lever 70 is being pressed in the H2 direction to teeth of the third pinion 62 in the side edge part 74a while resisting against a D2 direction spring force of the spring part 11, a rotation of the third wheel & pinion 60 containing the third pinion 62 is set and prohibited by the third pinion butting/setting part 74.

Under this state S2, if the winding stem 21 is rotated about the center axis B, since the minute wheel 28 is rotated through the clutch wheel 25, and the center wheel & pinion 40 and the hour wheel 30 which have meshed with the clutch wheel are rotated, hand settings of a minute hand and an hour hand, which are not shown in the drawing, are performed. Incidentally, since the mesh between the third wheel & and pinion 60 and the center wheel & pinion 40 is released by the third pinion butting/setting part 74, a rotation of the center wheel & pinion 40 is not transmitted to the second wheel & pinion 50. Further, since a rotation of the third wheel & pin/ion 60 is set or prohibited by the third pinion butting/setting part 74 pressed to the third pinion 62, there is no fear that the second wheel & pinion 50 rotates on the occasion of the hand setting, and there is also no fear that a second hand (not shown in the drawing) shakes (e.g., jerks) on the occasion of the hand setting. Accordingly, it is possible to cause the second hand to take an immovable, stable behavior on the occasion of the hand setting while suppressing the cost to the lowest limit.

In the above, although it has been explained about an example in which, under the state S1, the third pinion butting/setting part 74 of the lever 70 butts against the locking protrusion part 19 of the main plate 10, instead of it, there may be adapted such that, under the state S1, other portion of the lever 70 butts against the locking protrusion part. Incidentally, if desired, the locking protrusion part may not exist.

From the fact that, in compliance with a case where the winding stem 21 exists in the 0th stage and a case where it exists in the 1st stage, the lever 70 takes different positions, the lever 70 acts typically as a reset lever possessing a contact part contacting with and separating from a reset terminal (not shown in the drawing) in compliance with the case where the winding stem 21 exists in the 0th stage and the case where it exists in the 1st stage. However, the lever 70 is related to an arbitrary portion in which there is utilized an information discriminating whether the winding stem 21 exists in the 0th stage or exists in the 1st stage, thereby giving an information denoting the pulling-out state of the winding stem 21. Incidentally, in the example shown in the drawings, although the pulling-out of the winding stem 21 is performed by one stage, in such a case that a calendar mechanism is possessed, the winding stem 21 has pulling-out positions of two stages. In that case, the state S2 that the hand setting is performed becomes generally a state that the winding stem has been pulled out by two stages, i.e., winding stem 2nd stage state.

In the above, although it has been explained about an example in which the spring part possessing the bearing part supporting the end part 69 of the third spindle 67 is formed in the main plate 10, the spring part maybe formed in or engaged with other member instead of the main plate 10 (incidentally, the member disposed stationarily with respect to the case can be deemed to be equivalent to the main plate 10).

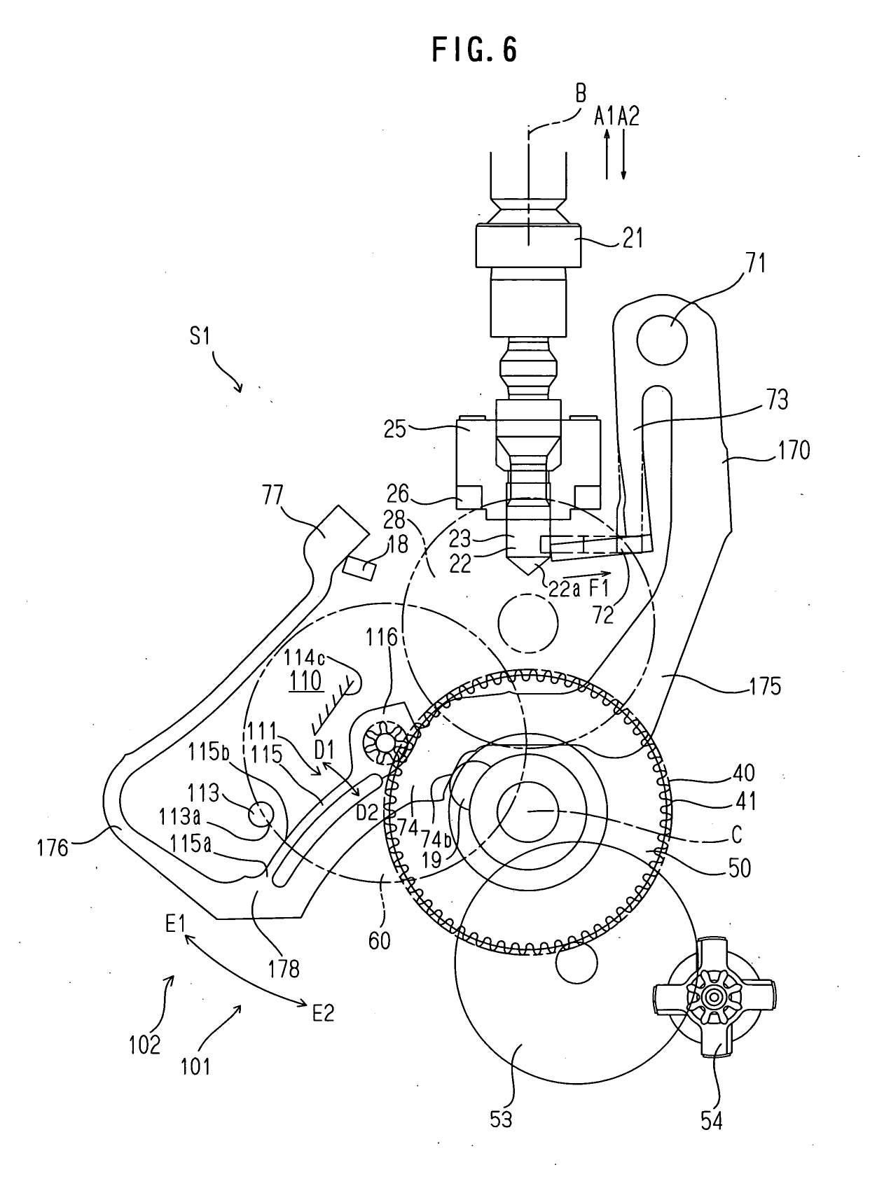

In FIG. 6 to FIG. 10, there is shown a timepiece 101 having a third wheel & pinion disengaging structure 102 of a modified example in which, instead of the main plate 10, the lever possesses the spring part. In the time piece 101 of this modified example, the same reference numeral is applied to the same member or part as the timepiece 1 of the embodiment shown in FIG. 1-FIG. 5, and a reference numeral in which 1 has been added to a place of 100 is applied to a partially different member or part.

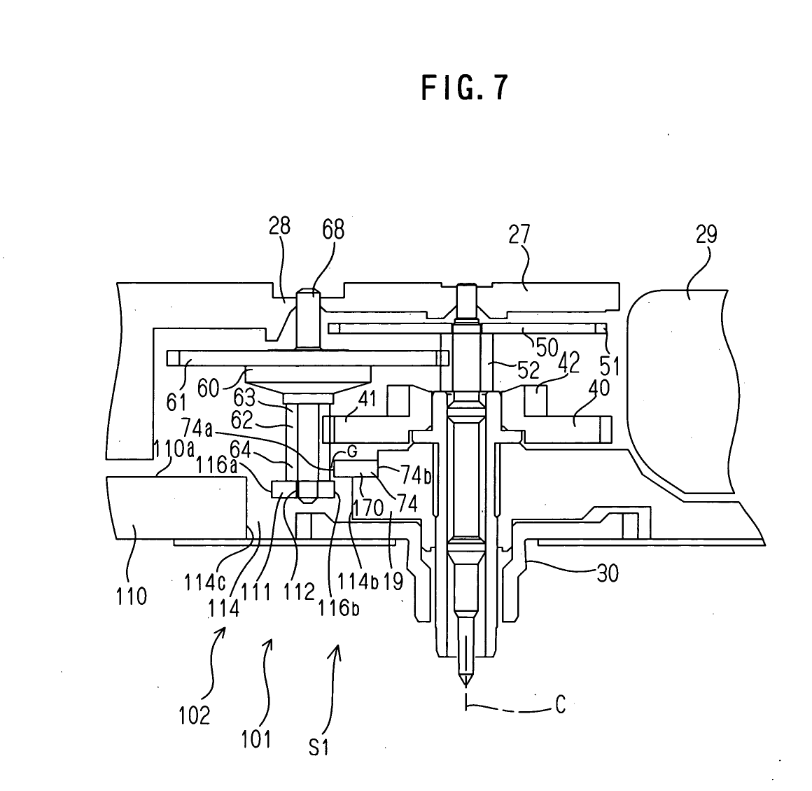

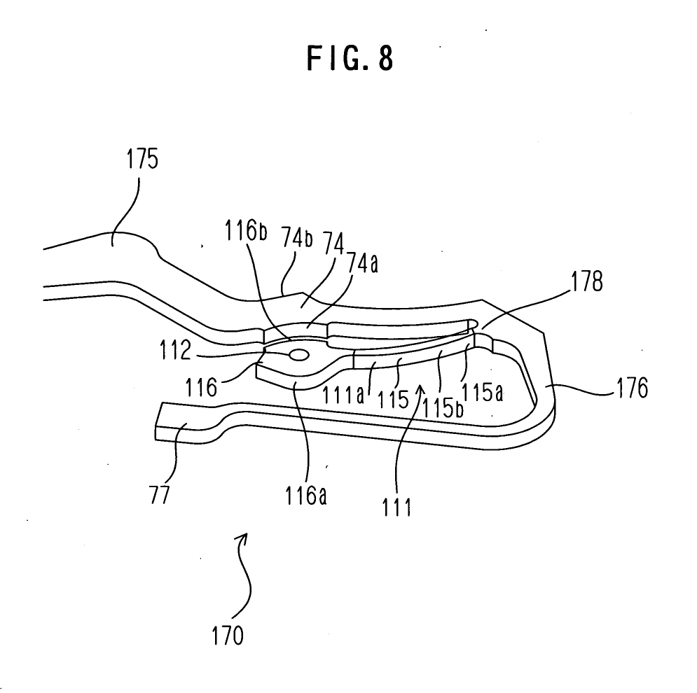

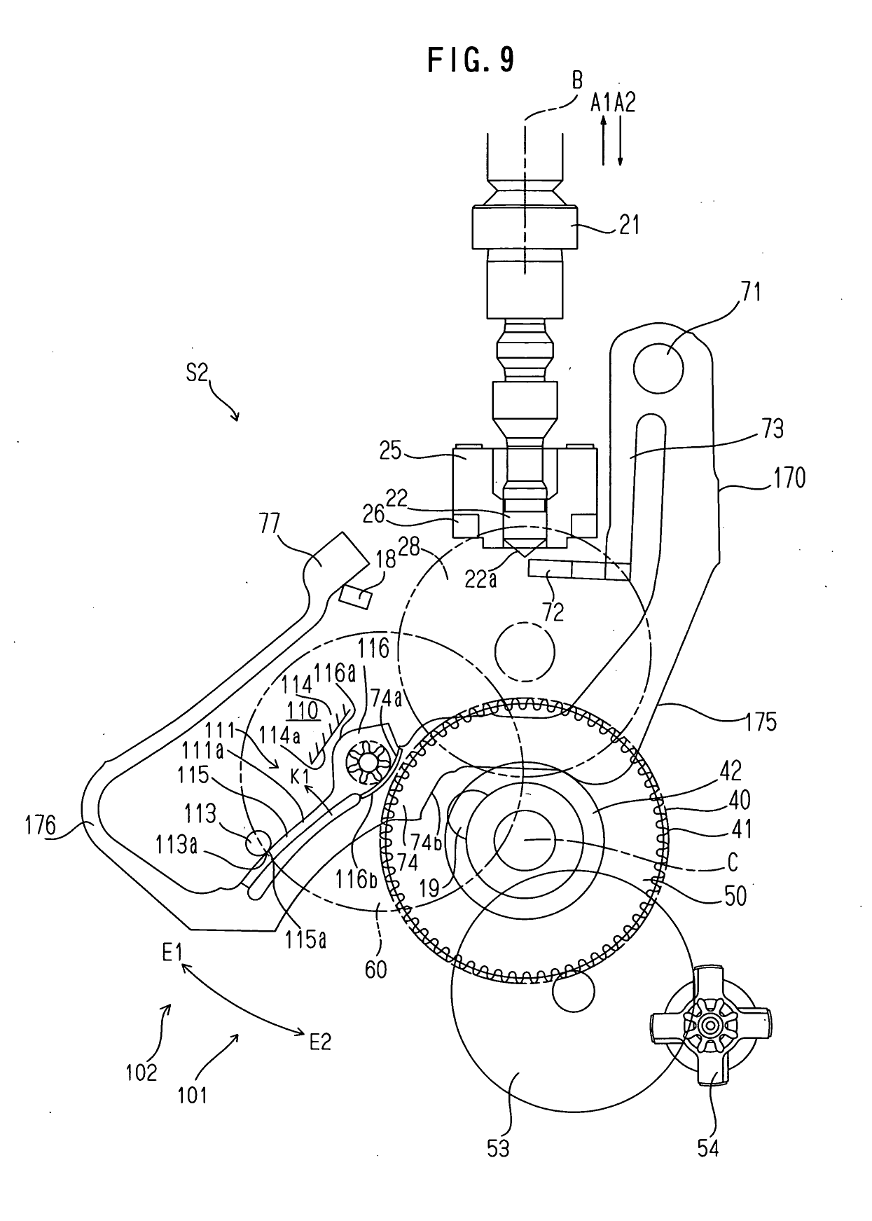

As understood from plan views of FIG. 6 and FIG. 9 and a perspective view of FIG. 8, a lever 170 has a third wheel & pinion biasing spring part 111 extending from a base end side portion 178 of a U-shaped spring part 176 to a place adjacent to the third pinion butting/setting part 74. The third wheel & pinion biasing spring part 111 has a bearing part 116 possessing a bearing hole 112 (FIG. 7 and the like) in a tip part of an arm part 115.

The lever 170 is located in substantially the same plane in portions other than the arm part 115, and rotatable in the E1, E2 directions about the axle 71 along a surface 110a of a main plate 110.

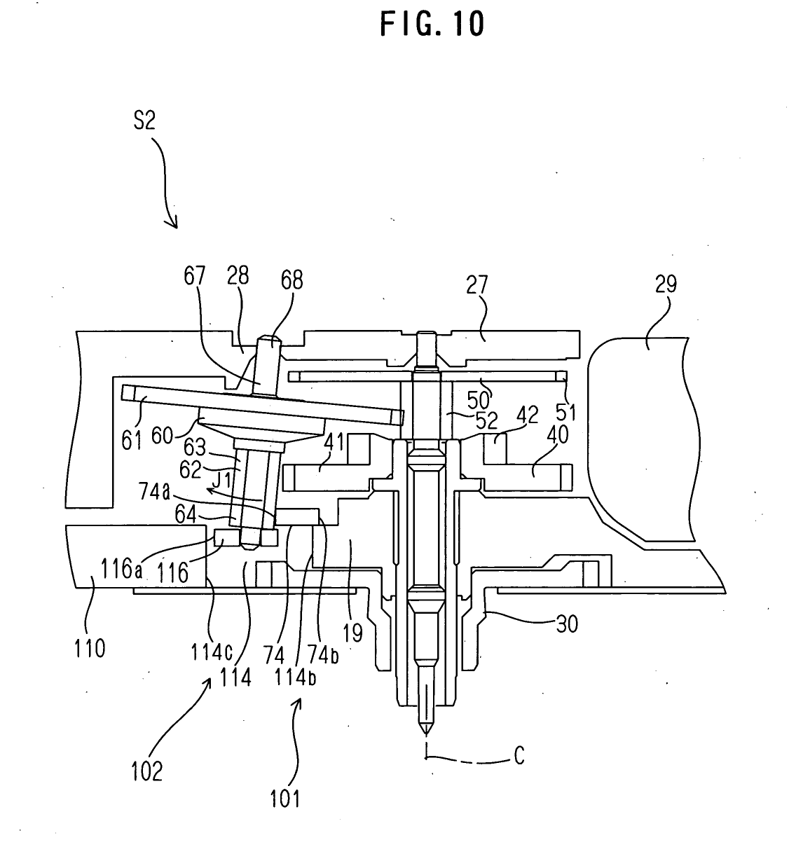

As understood from a perspective view of FIG. 8, the arm part 115 slantingly extends from a base end part 115a into an opening 114 (FIG. 7 and the like) of the main plate 110 so as to be located in a dial side as approaching the tip bearing part 116. Accordingly, as understood from FIG. 7 and FIG. 10, under a mounted state, side edges 116a and 116b of the tip bearing part 116 face on side edges 114c, 114b of the opening 114 of the main plate 110 in a horizontal direction. Here, the horizontal direction means an extension direction of a plane perpendicular to the center axis C. Incidentally, in a place facing in the horizontal direction on a side edge 115b in a part of about ⅓ from the base end 115a of the arm part 115 of the lever 170, the main plate 110 has a locking part 113 possessing a curved locking face 113a.

In the third wheel & pinion disengaging structure 102, of the timepiece 101, constituted like the above, under the winding stem 0th stage state S1 shown in FIG. 6 and FIG. 7, since the tip engaging part 22a of the tip part 22 of the winding stem 21 butts against the winding stem butting part 72 of the arm part 73 to thereby push the butting part 72 in the F1 direction, the lever 170 is rotated in the E2 direction, and an arm part 175 is also rotated in the E2 direction. As a result, the butting/setting part 74 of the arm part 175 of the lever 170 butts in the side edge 74b against the locking protrusion part 19 of the main plate 110. Incidentally, under the state S1, the arm part 73 is curved from a state shown by imaginary lines to a state shown by solid lines and, in compliance with an E2 direction torque resulting from its elastic deformation, the side edge 74b of the butting/setting part 74 is pressed to the locking protrusion part 19. Further, as shown in FIG. 7, under this state S1, the butting/setting part 74 of the arm part 175 of the lever 170 faces on the dial side portion 64 under a state that the side edge 74a is separated by the interstice G from the dial side portion 64 of the third pinion 62. Accordingly, as shown in FIG. 6 and FIG. 7, the case back side portion 63 of the third pinion 62 is pressed in the D2 direction to the center wheel 41 by the spring part 111 (at least, the spring part 111 prohibits the mesh between the case back side portion 63 of the third pinion 62 and the center wheel 41 from being released). In the above, it is similar to the case shown in FIG. 1 and FIG. 2 except a point that the spring part 111 is not one part of the main plate 110 but becomes one part of the lever 170.

On the other hand, if the winding stem 21 is pulled out in the A1 direction and becomes the winding stem 1st stage state S2, the third-wheel & pinion disengaging structure 102 of the timepiece 101 takes a state shown in FIG. 9 and FIG. 10.

When shifting from the winding stem 0th stage state S1 to the winding stem 1st stage state S2, since the tip engaging part 22a of the tip part 22 of the winding stem 21 separates from the winding stem butting part 72 of the arm part 73 of the lever 170, (the armpart 73, 175 of) the lever 170 is rotated in the E1 direction by the U-shaped spring part 76. Accordingly, the arm part 175 of the lever 170 is rotated in the E1 direction and, in compliance with it, the spring part 111 is also rotated in the E1 direction. If the spring part 111 is slightly rotated in the E1 direction, the side edge part 115b of the arm part 115 of the spring part 111 butts against the locking part 113 of the main plate 110. In this stage, although the third spindle 67 is somewhat swung in the J1 direction, the third pinion 62 and the center wheel 41 are kept in the meshing state. If the lever 170 is additionally rotated in the E1 direction, in compliance with it the third pinion setting/butting part 74 of the arm part 175 is rotated in the E1 direction. On the other hand, since the spring part 111 is restricted by the locking part 113, the butting part 74 approaches and butts against the dial side portion 64 of the third pinion 62 and, additionally, pushes the portion 64 in the E1 direction. Accordingly, a tip side portion 111a of the spring part 111 is curved in a K1 direction with the side edge part 115b having butted against the locking part 113 being made a center, the bearing part 116 is swung in the K1 direction, the third spindle 67 is swung in the J1 direction, and the mesh between the third pinion 62 and the center wheel 41 is released. If the lever 170 is additionally rotated in the E1 direction, the third pinion butting/setting part 74 is pressed to the corresponding part 64 of the third pinion 62 so as to additionally curve the tip side portion 111a of the spring part 111 in the K1 direction, thereby setting the third pinion 62.

As understood from FIG. 10, under this state S2, the third spindle 67 is swung in the J1 direction about the end part 68, and the mesh between the third pinion 62 and the center wheel 41 is released. Accordingly, the rotation of the minute wheel 28 accompanying the rotation of the winding stem 21 is not transmitted to the third wheel & pinion 60 and the second wheel &pinion 50. Further, since the butting/setting 74 of the lever 170 is pressed to the teeth of the third pinion 62, the rotation of the third wheel & pinion 60 is prohibited, so that there is no fear that the second wheel & pinion 50 rotates even if the impact from an outside and the like exist and thus there is no fear that the second hand shakes.

What is claimed is:

1. A third wheel & pinion disengaging structure wherein a lever rotated in a plane with respect to a base body in compliance with a putting-in/out of a winding stem possesses a third pinion setting part pressed to a third pinion in compliance with a pulling-out of the winding stem and causing the third pinion to separate from a center wheel.

2. A third wheel & pinion disengaging structure according to claim 1, further comprising:
a third wheel & pinion biasing spring having a hole part to which a third spindle is fitted and causing a third wheel & pinion to elastically bias to a position meshing with a center wheel & pinion; and
wherein the third pinion setting part of the lever is pressed to the third pinion in compliance with the pulling-out of the winding stem and causes the third pinion to separate from the center wheel while resisting against an elastic biasing force of the third wheel & pinion biasing spring.

3. A third wheel & pinion disengaging structure according to claim 2, wherein the spring is formed in the base body.

4. A third wheel & pinion disengaging structure according to claim 2, wherein the spring is formed in the lever.

5. A third wheel & pinion disengaging structure comprising:
a lever rotated in a plane with respect to a base body in compliance with a putting-in/out of a winding stem, and
a third wheel & pinion biasing spring formed in the base body, possessing a hole part to which a third spindle is fitted, and causing a third wheel & pinion to elastically bias to a position meshing with a center wheel & pinion,
wherein the lever has a third pinion setting part pressed to a third pinion in compliance with a pulling-out of the winding stem and causing the third pinion to separate from a center wheel while resisting against an elastic biasing force of the third wheel & pinion biasing spring.

6. A timepiece possessing a third wheel & pinion disengaging structure according to claim 1.

7. A timepiece possessing a third wheel & pinion disengaging structure according to claim 5.
